(19) United States
(12) Patent Application Publication
(10) Pub. No.: US 2026/0253015 A1
(43) Pub. Date: Aug. 27, 2026

(54) SYSTEM AND METHOD FOR EVALUATION OF EMPLOYEE PERFORMANCE

(71) Applicant: Kingfisher Innovations, Inc., Houston, TX (US)

(72) Inventors: Andrew Brett Gilmer, Parkland, FL (US); Mitchell Gilmer, Wauwatosa, WI (US); Steve Gotberg, Corpus Christi, TX (US); Theresa Ruiz, Little Elm, TX (US); RhaeAnn C. Stark, Corpus Christi, TX (US); Mitchell Kalogridis, Houston, TX (US)

(73) Assignee: Kingfisher Innovations, Inc., Houston, TX (US)

(21) Appl. No.: 19/172,348

(22) Filed: Apr. 7, 2025

Related U.S. Application Data
(63) Continuation-in-part of application No. 19/063,690, filed on Feb. 26, 2025.

(51) Int. Cl. G06Q 10/0639; G06Q 10/0631

(52) U.S. Cl. CPC G06Q 10/06393; G06Q 10/063112; G06Q 10/063114

(57) ABSTRACT

A disclosed system and method provide a data-driven employee evaluation platform that utilizes statistical techniques and machine learning algorithms to deliver objective and unbiased performance assessments. The disclosed system collects and analyzes a comprehensive set of Key Performance Indicators (KPIs), which are customizable to meet the specific requirements of individual organizations. An extensible architecture allows seamless integration of user-defined KPIs into the evaluation process. The disclosed method generates regular evaluations designed to minimize personal and legal biases, providing transparent and data-backed performance insights to both employers and employees. Employees receive clear feedback illustrating their performance relative to peers, along with actionable recommendations for improvement. Additionally, the system promotes employee engagement by awarding tokens based on performance, which can be redeemed for approved rewards, thereby incentivizing continuous improvement and alignment with organizational goals.

### REFERENCE TO RELATED APPLICATION

This patent application is a continuation in part of patent application Ser. No. 19/063,690 filed on Feb. 26, 2025, the contents of which are incorporated herein by reference.

### FIELD

The present invention relates to performance evaluation systems and more particularly to the system and method for evaluating performance of employees based on AI-based recommendations and data driven rankings.

### BACKGROUND

Employee performance evaluations are a crucial component of organizational success, as they influence promotions, salary adjustments, training requirements, and overall workforce efficiency. However, traditional performance review methods suffer from numerous shortcomings that hinder their effectiveness. One of the most significant challenges is the subjectivity inherent in manual evaluations. Managers tasked with assessing their employees must rely on the information available to them, which is often incomplete and influenced by personal biases. This can result in undue criticism for some employees while others receive disproportionately favourable reviews due to personal relationships with their supervisors.

A further complication in conventional review processes is the infrequency of evaluations. Employees often receive performance feedback only during annual or semi-annual reviews, which are perceived as high-stakes events. These reviews tend to focus on selective incidents rather than an employee's overall contribution, and as a result, employees may feel that they are being judged unfairly. Negative reviews can create defensiveness and disengagement, while positive feedback is often fleeting and quickly forgotten. Without consistent, data-backed evaluations, employees lack the necessary guidance to understand their strengths and areas for improvement in a timely manner.

Beyond these limitations, traditional review methods fail to provide a comprehensive, quantitative measure of an employee's contributions. Many critical aspects of job performance, such as leadership ability, teamwork, efficiency, and customer satisfaction, are difficult to measure objectively. Moreover, employees working under different conditions—such as those assigned to peak business hours versus those on less demanding shifts—are often evaluated without accounting for the varying difficulty of their roles. This discrepancy further exacerbates employee dissatisfaction and creates an inaccurate representation of performance.

To address these challenges, there is a need for an advanced, automated system that provides frequent, objective, and quantifiable performance evaluations. Such a system should integrate real-time data, minimize managerial bias, and allow employees to track their own progress. Furthermore, it should include mechanisms for motivating employees by linking performance metrics to tangible rewards, thereby fostering a culture of continuous improvement and engagement.

### SUMMARY

The following summary is illustrative only and is not intended to be in any way limiting. In addition to the illustrative aspects, example embodiments, and features described, further aspects, example embodiments, and features, will become apparent by reference to the drawings and the following detailed description.

An embodiment of the present invention is, an intelligent, automated system designed to evaluate employee performance using quantifiable KPIs. Unlike traditional methods, this system eliminates subjectivity by relying on structured, real-time data imported from various organizational sources. The platform provides businesses with the flexibility to define performance metrics that align with their operational goals, while simultaneously ensuring that evaluations are role-specific and unbiased.

The system operates by collecting performance data from multiple sources, such as point-of-sale (POS) systems, time clocks, inventory management systems, and other workforce management tools. Through the use of APIs and Webhooks, the invention seamlessly integrates with third-party applications, ensuring that employee performance is assessed based on actual operational data rather than subjective observations. The platform is also equipped with an intuitive interface that allows managers to configure KPI weightings for different job roles, ensuring that employees are evaluated based on criteria relevant to their specific responsibilities.

A key feature of the system is its AI-driven ranking algorithm, which analyzes performance data to generate objective evaluations. Employees are ranked based on a combination of organizational expectations and peer-group comparisons. By evaluating workers within the same job category and shift conditions, the system ensures fairness in ranking and identifies performance trends that might be obscured in traditional evaluations. Additionally, the AI component is capable of detecting anomalies, such as unexpected deviations in rankings, which may indicate systemic issues or unrealistic expectations within the organization.

The disclosed platform hereinafter not only provides employees with transparent access to their performance metrics but also generates personalized feedback. Through an integrated web and mobile interface, employees can monitor their ranking trends over time, receive AI-generated recommendations on how to improve their performance, and be alerted when their ranking is at risk of decline. This proactive approach allows employees to take corrective actions before a performance issue becomes significant.

Moreover, the invention incorporates a reward system that gamifies performance tracking. Organizations have the option to enroll employees in the Awards System, which issues tokens based on performance achievements. These tokens can be accumulated and redeemed for company-branded merchandise, gift cards, or other employer-approved incentives. By linking performance to tangible rewards, the system encourages continuous improvement and enhances employee engagement.

Additionally, the invention supports a training module that suggests personalized learning content based on KPI deficiencies. If an employee is struggling with punctuality, for example, the system may recommend time management training. Similarly, if an employee's sales performance is below expectations, they may receive targeted training on customer engagement techniques. Completion of these training modules contributes to an employee's overall ranking and provides a structured path for performance enhancement.

The disclosed platform also includes an AI-powered analytics module that evaluates the effectiveness of various KPIs in relation to overall business profitability. By analyzing historical data, the system can determine which performance metrics have the most significant impact on financial success and suggest adjustments to KPI weightings accordingly. This feature allows businesses to continuously refine their evaluation criteria to align with their strategic goals.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates an environment 100 in which various embodiments of the present disclosure is practiced;

FIG. 2 illustrates a graphical display of a KPI ranking threshold, according to an embodiment of the present disclosure;

FIG. 3 illustrates a graphical interface of configuring weight of each KPI applicable to an employee role, according to an embodiment of the present disclosure;

FIG. 4 illustrates a graphical interface of ranking one or more employees in an employee role and against a set of KPIs, according to an embodiment of the present disclosure;

FIG. 5 illustrates a graphical interface, where evaluation are published, according to an embodiment of the present disclosure;

FIGS. 6A-6C illustrates a method of ranking employees based on employee KPI and contextualized performance data, according to an embodiment of the present disclosure;

FIGS. 6D-6E illustrates a method of awarding the employees based on employee KPI and contextualized performance data, according to an embodiment of the present disclosure;

FIG. 7 illustrates a method of performing KPI reflection, according to an embodiment of the present disclosure; and

FIG. 8 illustrates a method of configuring Key Performance Indicators (KPIs) on a web user interface, according to an embodiment of the present disclosure.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Similarly, like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any, and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, elements, and/or components, but do not preclude the presence or addition of one or more other features, integers, steps, operations, elements, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skills in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The present system comprises several interconnected components that work together to collect, process, analyze, and present employee performance data. The following section provides an in-depth explanation of how each module of the system functions, with specific reference to the associated figures and diagrams that illustrate the working mechanism of the invention. These figures provide visual representations of the data import process, KPI ranking system, peer-based comparison framework, AI-driven analytics, employee performance dashboards, and the rewards mechanism.

The platform is designed to generate objective, bias-free employee evaluations and feedback by leveraging multiple quantifiable key performance indicators (KPIs) that are both crucial to the employer and often difficult to measure. Unlike traditional evaluation methods that may be influenced by personal bias or incomplete managerial oversight, it ensures fairness and accuracy by allowing each KPI to be weighted individually based on the specific role of the employee, such as a cashier or sales manager. This customization enables organizations to tailor performance evaluations to the unique responsibilities of different job positions, ensuring that each employee is assessed according to criteria most relevant to their role.

By implementing a completely impartial ranking system, the system eliminates any bias related to employee protection status, personal relationships, or subjective managerial preferences. This not only fosters transparency in performance reviews but also shields managers from accusations of favoritism, discrimination, or unfair treatment. The system automatically generates employee rankings alongside detailed evaluation reports, significantly reducing the administrative burden on managers. With less time spent on manually compiling and analyzing performance data, managers can instead focus on core business operations, making workforce evaluations a streamlined and efficient process.

To maximize the effectiveness of employee feedback, the system offers flexible evaluation intervals that can be configured by the organization. While traditional performance reviews are often conducted annually or semi-annually, the system enables evaluations to be published daily or weekly, ensuring that employees receive timely and actionable feedback. This continuous evaluation approach helps employees track their progress in real-time and make necessary improvements before performance issues escalate. Furthermore, the system allows organizations to modify KPI weightings at any time, enabling businesses to test different evaluation criteria, analyze how these changes would have influenced recent employee assessments, and make data-driven adjustments going forward.

Beyond performance evaluations, in an embodiment of the invention the system also functions as a comprehensive workforce management tool by exporting evaluation data to third-party systems, such as scheduling applications, human resource information systems (HRIS), or human resource management systems (HRMS). This integration is facilitated through direct data downloads, Webhook connections, or REST APIs, ensuring seamless interoperability with existing business software. By linking employee performance data with scheduling or HR platforms, organizations can make more informed decisions about workforce planning, promotions, and training programs.

Additionally, the system can incorporate a reward system designed to recognize and incentivize high-performing employees. As an optional feature, the platform allows employees to earn reward tokens based on their performance metrics. These tokens can be accumulated and redeemed for branded merchandise, gift cards, or other company-approved incentives. This gamified approach not only reinforces positive workplace behaviors but also keeps financial costs contained while encouraging employees to remain engaged with their performance goals. By integrating real-time performance tracking, transparent evaluation metrics, and tangible rewards, the system offers an innovative and dynamic solution for organizations seeking to improve their employee management, motivation, and overall business efficiency.

The present invention relates to a computerized system and method for generating unbiased, role-specific employee evaluations and feedback reports based on multiple Key Performance Indicators (KPIs) that are significant to the employer, including those that may not be readily quantifiable by traditional evaluation methods. The system is configured to collect, process, and analyze performance data corresponding to various employees within an organization. Each employee is assigned one or more KPIs based on their designated role (for example, cashier, sales manager, or equivalent positions). The KPIs are weighed individually according to the importance of each performance criterion relative to the specific role. These weights are configurable and may be modified by an administrative user at any time. The system employs algorithmic processing to aggregate the weighted KPI data for each employee to generate a ranking that objectively reflects employee performance. The evaluation process is designed to be bias-free, ensuring that employee personal attributes such as protection status, personal relationships, gender, nationality, or any other potential source of discrimination do not influence the rankings. By automating the evaluation process, the system minimizes subjective managerial influence, thereby protecting both the employee and the employer from claims of discriminatory or preferential treatment.

The platform generates detailed employee evaluation reports that include both quantitative performance rankings and qualitative feedback, which can be configured to be generated and published at intervals determined by the organization, such as daily, weekly, or at other predefined timeframes. The system further includes a dynamic weighting module that allows an administrator to modify the weights assigned to individual KPIs for specific roles and review a simulation of the potential impact such changes would have had on recent or historical evaluations before applying the new weightings to future assessments. This functionality allows organizations to continually refine their evaluation criteria to align with evolving business objectives or role-specific requirements.

Additionally, the system is capable of exporting employee evaluation data in multiple formats for integration with third-party systems, such as workforce scheduling software, Human Resource Information Systems (HRIS), or Human Resource Management Systems (HRMS). The export functionality is facilitated via direct data downloads, Webhooks, or RESTful API interfaces, providing seamless data transfer and interoperability with external applications. Furthermore, the platform includes an optional rewards module that allows employees to earn digital reward tokens based on their performance evaluations. These tokens can be accumulated and redeemed for organizationally branded merchandise, gift cards, or other predefined incentives as determined by the employer. This reward mechanism provides a recurring expression of recognition and appreciation for high-performing employees, while promoting the organization's brand and maintaining cost efficiency.

By automating employee evaluations through objective, data-driven methods, and integrating performance-based incentives, the platform not only enhances transparency and fairness in employee assessments but also streamlines managerial tasks, enabling managers to allocate more time to strategic decision-making and other core business functions. The invention offers a scalable and customizable solution applicable across various industries seeking to improve employee performance management, foster engagement, and ensure compliance with fair evaluation practices.

The present disclosure relates to an employee evaluation system designed to quantitatively assess employee performance using Key Performance Indicators (KPIs), enabling organizations to make data-driven decisions regarding workforce management. The system allows for the creation of custom, customer-defined KPIs that are read from various internal or external sources, such as point-of-sale data, scheduling systems, or HIR platforms. These KPIs are weighted based on employee roles, and employer-defined thresholds are applied to generate rankings per KPI. The system classifies each employee into an overall ranking level, utilizing artificial intelligence (AI) to provide an objective and dynamic classification. For each employee and role pairing, a comprehensive evaluation report is generated that provides detailed insights into individual performance.

In one embodiment, the system includes a Performance Contextualization Engine that leverages machine learning algorithms to observe trends across different work shifts and correlate those with performance metrics. This engine adjusts or “curves” observed performance data to reflect the difficulty level of specific working conditions, providing a fairer and more accurate assessment of employee performance. The system also enables ranking employees against their peer groups, offering deeper insight into relative performance within specific roles or teams. Additionally, AI algorithms analyze the impact of each KPI on overall profitability over time, providing feedback when the current KPI weighting does not accurately reflect its contribution. The system may also identify and recommend new KPIs that can drive better business outcomes.

The employee evaluation system includes an interactive feedback interface through which employees can access their evaluation reports, view their rankings, and receive personalized tips for improving their performance. This interface may also recommend targeted online training courses based on the employee's KPI rankings. Employees can improve their rankings by completing recommended training sessions, which in turn can earn them rewards in the form of tokens or a virtual currency. High performance and training completion are incentivized through a token-based reward system, where tokens can be exchanged for organization-approved merchandise or gift cards through an integrated redemption platform.

Another embodiment described herein is a KPI Reflection System, which inputs KPIs, employee rankings, timesheet data, and business performance data corresponding to specific time periods. This system correlates KPI rankings against actual business outcomes to assess the efficiency and causality between measured KPIs and organizational success. Reports generated by the KPI Reflection System suggest changes to KPI weights or rankings, ensuring that the KPIs contributing most significantly to positive business outcomes are weighted appropriately. This dynamic feedback loop enables organizations to continuously refine their performance evaluation criteria, aligning employee performance management with strategic business objectives.

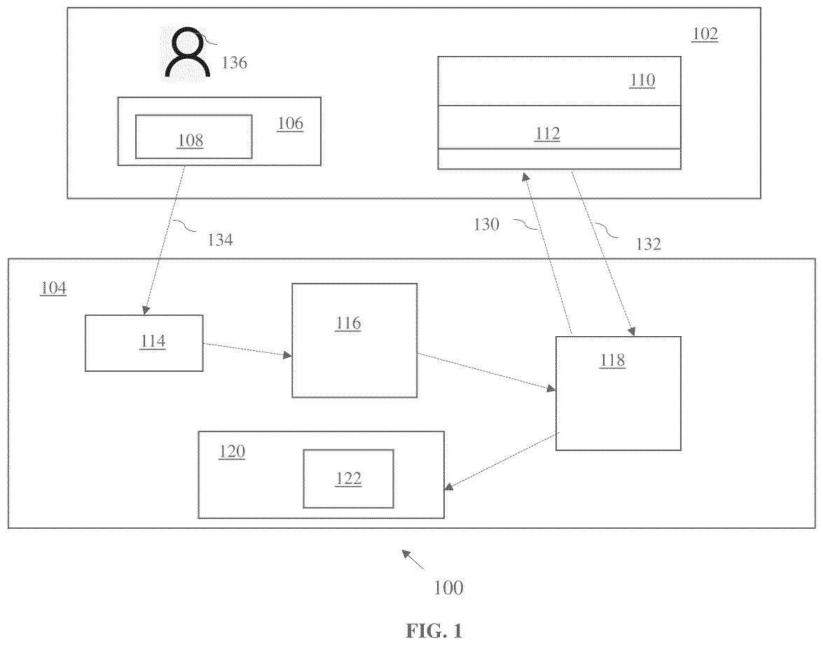

FIG. 1 illustrates an environment 100 in which various embodiments of the present disclosure are practiced. The environment 100 includes a customer network 102, and a repository 104 of customer KPIs. The customer network 102 illustrates a customer 102, of an organization that is communicating with a web browser 106, that hosts a web application 108. The customer network 102 further includes a custom KPI provider 110, that implements a webhook implementation 112. The repository 104, includes backend database 114, an employee KPI database 116 that holds standard KPI (e.g. standard KPI 1, standard KPI 2, . . . standard KPI n, and a custom KPI webhook), an insight engine 118, and an employee evaluation database 120.

The backend database 114, communicates with the employee KPI database 116. The web application 108 configures the backend database 114 via communication 134. The insight engine 118 is capable of communicating with 116 and 120 and with the custom KPI provider 110. Typically, the customer KPI provider 110 provides employee KPI measurement via communication link 132 and receives employee data via communication link 130. The insight engine 118 typically processes the standard KPIs received from the employee KPI database 116. In this manner, the webhook integration collects multiple employee KPIs from external sources.

The system is configured to be ready for deployment and customization immediately upon an organization's enrollment within the ecosystem. Upon initialization, the system provides a predefined and comprehensive set of Key Performance Indicators (KPIs), which are established based on common operational and performance measurement requirements typically encountered across various industries. These predefined KPIs may include, but are not limited to, metrics such as employee attendance, individual and team sales performance, gratuity collections, and other quantifiable data points relevant to organizational management. Each KPI in the system is associated with one or more industry classifications, such as restaurant, retail, manufacturing, or similar sectors, thereby enabling an enrolling organization to easily identify and select KPIs that align with its specific business operations.

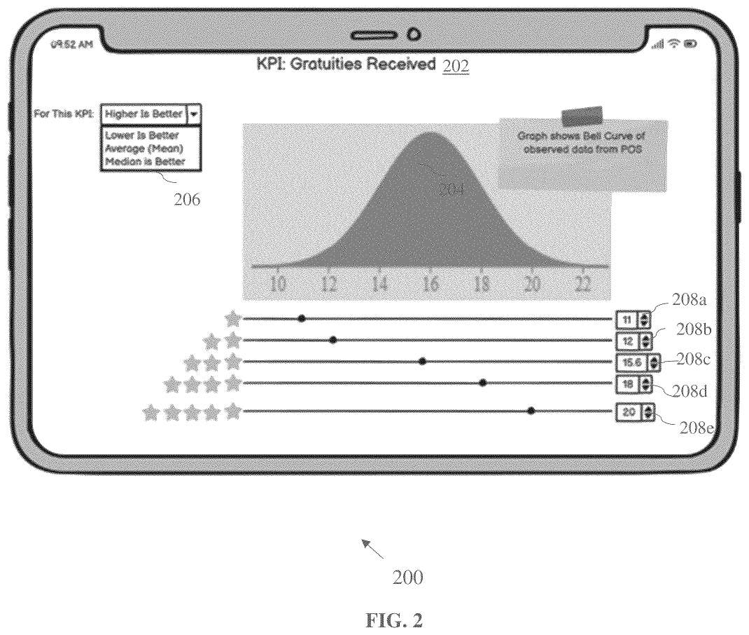

In addition to the predefined KPIs, the system is designed to be extensible, allowing administrative users within the organization to define and incorporate custom KPIs tailored to the unique requirements of their business. This extensibility ensures that the system remains adaptable and scalable across a diverse range of operational environments. When a new KPI is defined within the system, the platform automatically retrieves and loads historical data relevant to the selected KPI, if available, and generates a graphical display of the data over a defined time period. This graphical representation provides administrators with a visual reference to assist in establishing or adjusting ranking thresholds for the KPI in question. The system enables each KPI ranking threshold to be individually configured based on the organization's performance expectations and operational benchmarks. These thresholds are user-adjustable at any time through the administrative interface, providing flexibility to adapt to evolving business priorities or performance standards. Although the historical data and graphical displays serve an informational purpose to guide administrators in making informed decisions, such data is not necessarily factored directly into the ranking calculations unless explicitly configured to do so by the organization. Ranking of a KPI is further explained with respect to FIG. 2.

FIG. 2 illustrates an example graphical display 200 representing the ranking thresholds associated with a Key Performance Indicator (KPI), specifically relating to gratuities received, referenced as KPI 202, in accordance with an embodiment of the present disclosure. As shown, the KPI 202 can be categorized and ranked according to predetermined classifications such as “Higher,” “Lower,” “Average,” or “Median,” as indicated by reference numeral 206. The graphical representation 204 depicts a bell curve, illustrating the distribution of gratuities received over a given period, with the data sourced from a point-of-sale (POS) system. In addition, the graphical display includes various rating indicators 208a through 208e, which correspond to specific star ratings based on gratuity values of 11, 12, 15.6, 18, and 20, respectively. These star ratings provide a visual indication of employee performance in relation to the gratuities received KPI, enabling organizations to assess and rank employees in a consistent and data-driven manner.

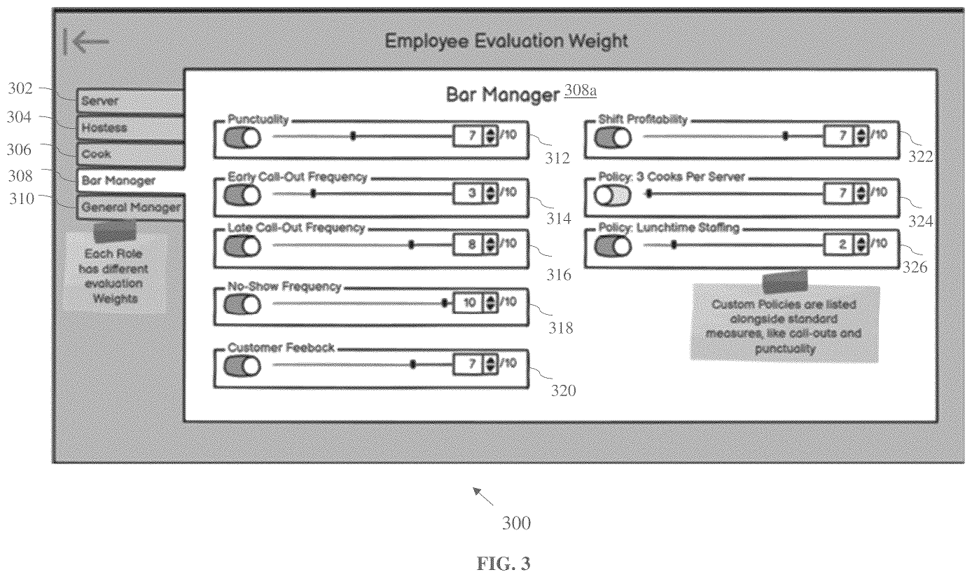

FIG. 3 illustrates an example graphical user interface 300 configured for assigning and adjusting the weight of each Key Performance Indicator (KPI) applicable to a specific employee role 308a (e.g., Bar Manager), in accordance with an embodiment of the present disclosure. As depicted, the interface displays a plurality of distinct employee roles, including, but not limited to, Server 302, Hostess 304, Cook 306, Bar Manager 308, and General Manager 310. Each role may be associated with different KPIs, wherein the relative importance or weight assigned to each KPI can be configured individually. In the illustrated example, the KPIs applicable to the Bar Manager role 308 include: a Punctuality KPI 312 assigned a weight of 7, an Early Call-Out Frequency KPI 314 assigned a weight of 2, a Late Call-Out Frequency KPI 316 assigned a weight of 8, a No-Show Frequency KPI 318 assigned a weight of 10, a Customer Feedback KPI 320 assigned a weight of 7, a Shift Profitability KPI 322 assigned a weight of 7, a Policy KPI enforcing three cooks per server 324 assigned a weight of 7, and a Policy KPI relating to lunchtime staffing 326 assigned a weight of 2. The interface allows both standard performance measures (such as call-outs and punctuality) and custom policy-based KPIs to be configured in accordance with the operational objectives of the organization. The ability to assign and adjust weights to individual KPIs on a per-role basis facilitates the generation of role-specific, data-driven employee evaluations.

In accordance with an embodiment of the present disclosure, the system enables the assignment of weighted values to each Key Performance Indicator (KPI) based on the specific employee role or job description within the organization. Each KPI considered in the employee evaluation process is assigned an “importance” rating, which is configured by the employer to reflect the relevance of that KPI to particular roles. The system allows for differentiated weighting of KPIs across various roles, ensuring that certain performance metrics are emphasized more heavily for roles where they are of greater significance. For example, a KPI such as shift profitability may be a critical component of the performance evaluation for a managerial role, such as a Bar Manager, whereas the same KPI may be deemed irrelevant for other roles, such as a Hostess or Busser, and therefore excluded from their evaluation criteria. The system provides an intuitive interface through which an organization may configure the applicable KPIs for each role and define the relative weight or importance assigned to each KPI. This configuration ensures that employee evaluations are role-specific, objective, and aligned with the operational priorities of the organization.

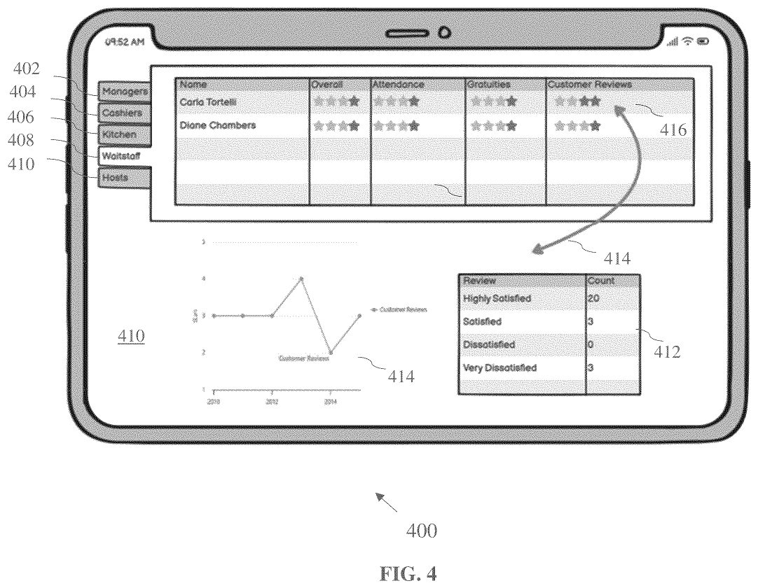

FIG. 4 illustrates an example graphical user interface 400 configured for ranking one or more employees within a specific employee role, based on a predefined set of Key Performance Indicators (KPIs), in accordance with an embodiment of the present disclosure. As shown, employees are categorized according to their designated roles, which may include, but are not limited to, Managers 402, Cashiers 404, Kitchen Staff 406, Waitstaff 408, and Hosts 410. Each employee within these categories is assigned a performance rating derived from their evaluation against multiple KPIs. For instance, within the Waitstaff category 408, two employees, namely “Carla Tortelli” and “Diane Chambers,” are assessed and provided ratings under various evaluation parameters, including but not limited to, Overall Performance, Attendance, Gratuities, and Customer Reviews. Specifically, the Customer Review score 416 for the employee “Carla Tortelli” is depicted and further analyzed. The interface displays a graph 418 illustrating the distribution of customer review scores that resulted in a two-star rating for this KPI. Additionally, a corresponding table 412 provides a breakdown of customer feedback data, including the number of responses categorized as Highly Satisfied (20), Satisfied (3), Dissatisfied (0), and Very Dissatisfied (3). This interface facilitates comprehensive analysis of employee performance by allowing visual and tabular inspection of underlying evaluation data contributing to each rating.

In accordance with an embodiment of the present disclosure, employee evaluations are automatically generated by processing organization-defined Key Performance Indicators (KPIs) using data supplied by the organization through webhooks and/or direct data import interfaces. The system utilizes modern artificial intelligence (AI) technologies in conjunction with traditional statistical models to analyze the performance data and generate comprehensive evaluation reports. As part of the evaluation process, each employee is ranked not only against the organization's predefined expectations but also in comparison to their peer group. In the context of the invention defines an employee's peer group as other employees performing the same role during similar time periods or shift types. This peer-based comparison framework ensures equitable evaluation standards by accounting for the varying degrees of difficulty associated with different shifts. For example, an employee, such as a cook or server, assigned to a low-intensity lunch shift is not directly compared to employees working high-demand shifts, such as weekend dinner rushes. Furthermore, the system automatically detects anomalies in employee rankings, particularly when discrepancies arise between an employee's performance as measured by pure KPI metrics and their relative ranking within their peer group. Such divergences may indicate systemic issues or unrealistic performance expectations within the organization, which can then be identified and addressed through further analysis.

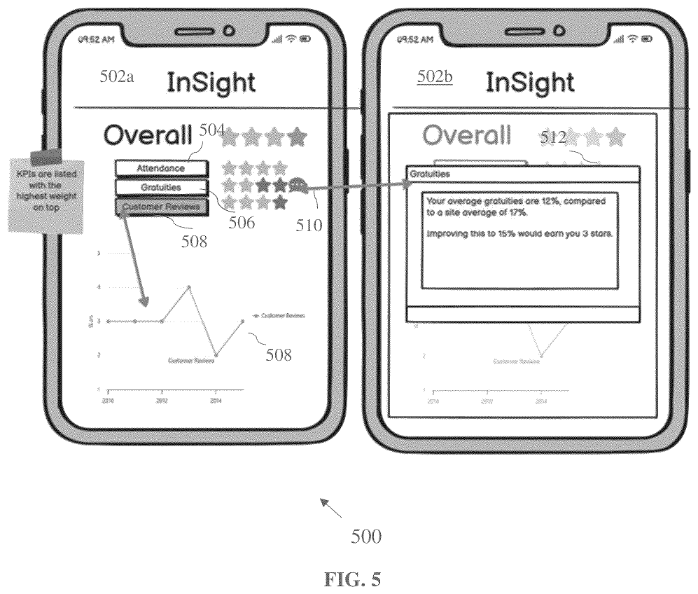

FIG. 5 illustrates an example graphical user interface 500 configured to display the publication of an employee evaluation, in accordance with an embodiment of the present disclosure. As shown, an evaluation summary 502a presents an overall performance rating for the employee, including specific Key Performance Indicators (KPIs) such as Attendance 504, Gratuities 506, and Customer Reviews 508. In the illustrated example, the employee has received zero stars for Attendance 504, two stars for Gratuities 506, and one star for Customer Reviews 508. Additionally, a graphical representation 508 provides further visual insight into the employee's performance data. In another example view 502b, detailed feedback related to the Gratuities KPI 506 is displayed when selected by the user. In this instance, the feedback indicates: “Your average gratuities are 12% compared to a site average of 17%. Improving this to 15% would earn you 3 stars.” Such feedback is dynamically presented on the graphical interface to provide actionable insights to the employee. This enables the employee to clearly understand their current KPI performance and identify specific areas for improvement. The interactive and informative nature of the feedback facilitates continuous performance enhancement by offering measurable goals aligned with organizational expectations.

In accordance with an embodiment of the present disclosure, the system provides a mechanism for importing Key Performance Indicator (KPI) data from external sources through a configurable webhook registration interface. This interface enables an organization to seamlessly integrate raw performance data originating from multiple external systems, including but not limited to Point-of-Sale (POS) systems, employee timeclock systems, inventory management platforms, and other components within the ecosystem. In some embodiments, the system includes pre-configured integrations with various industry-standard data sources to facilitate rapid deployment and data synchronization. Additionally, the system allows for the incorporation of performance data from any external source by enabling direct import via either Comma-Separated Values (CSV) files, also we can support import of excel spreadsheets (*.xls and related) or HTTP(s)-based webhooks. For webhook-based data integration, the registered webhooks are required to return performance data in a standardized JavaScript Object Notation (JSON) format. This JSON payload includes information such as the applicable time period for each measurement, the names or identifiers of the KPIs being reported, the corresponding Employee Identification (ID), and the associated performance measurement values. Alternatively, the system provides a file import interface through which users can upload KPI data in CSV format. This file-based interface supports both manual and automated bulk data import operations. Furthermore, in certain embodiments, the system utilizes artificial intelligence (AI) features to analyze imported bulk data in order to identify potential new KPIs that exhibit a statistically significant correlation with key operational outcomes, such as shift profitability. These advanced data import and analysis capabilities enable the system to continuously adapt and optimize employee performance evaluation metrics based on evolving organizational needs and data-driven insights.

Below is a snapshot of data import for gratuities:

{
| | [
| | | “period” : [“2025-02-08T21:00:00Z”, “2025-02-08T24:00:00Z”,]
| | | “gratuities” : {
| | | | | | “employee_1” : [15.0, 15.5, 20.1, 18.0]
| | | | | | “employee_2” : [17.0, 15.2, 10.0, 0.0, 12.5]
| | | }
| | ]
}

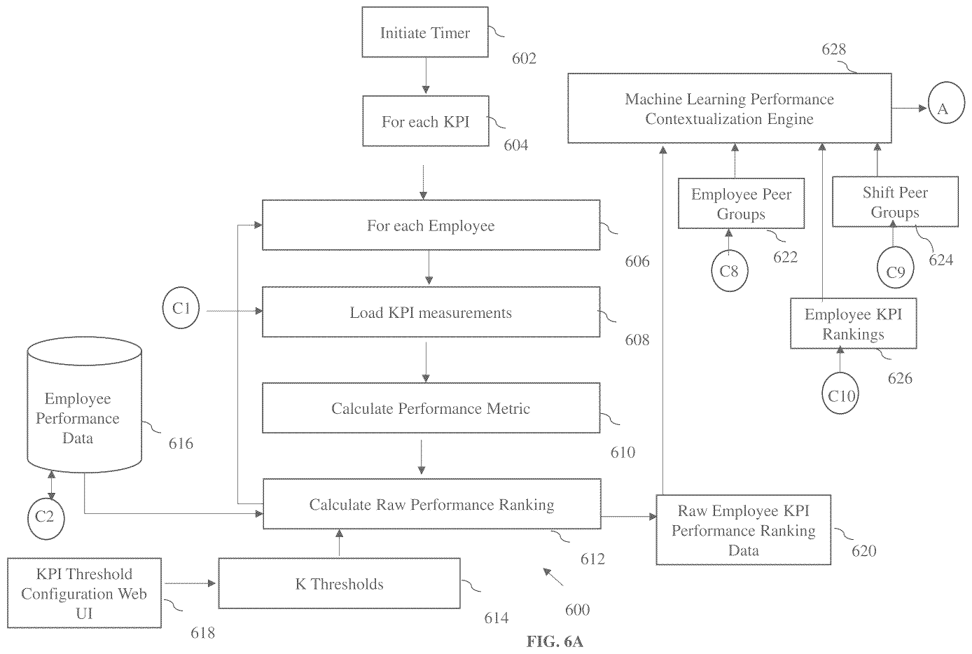

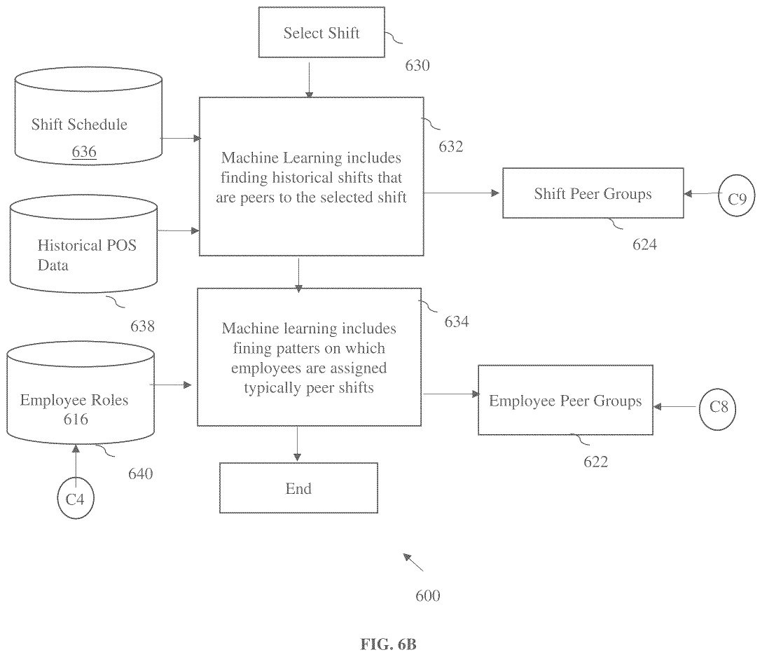

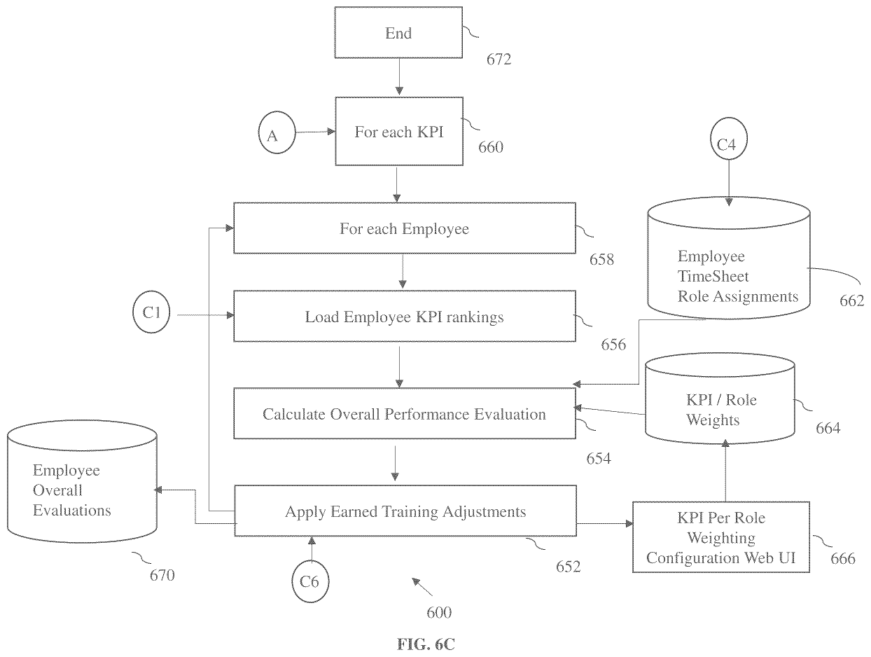

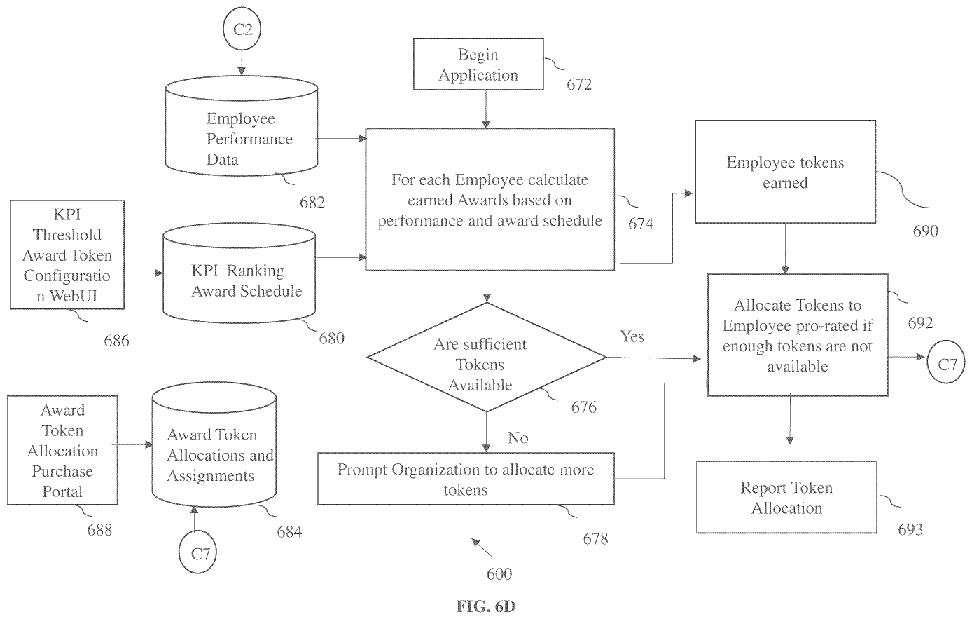

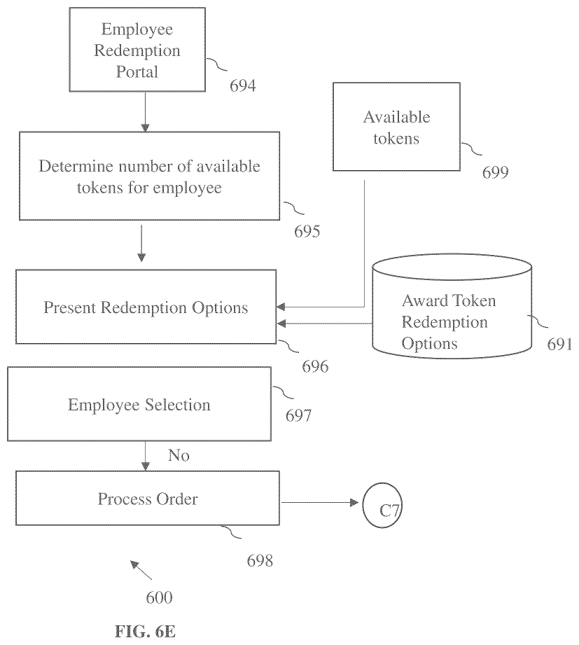

FIGS. 6A-6D illustrates a method 600 of ranking employees based on employee KPI and contextualized performance data, according to an embodiment of the present disclosure. The method of raking is explained hereinbelow. In accordance with an embodiment of the present disclosure, employees are ranked based on each Key Performance Indicator (KPI) that is factored into their overall evaluation, with a cumulative or roll-up score being generated by applying the corresponding KPI weights defined by the organization. The evaluation process is carried out in multiple stages to ensure accuracy and contextual relevance. In the initial stage, a ‘raw’ or ‘naive’ evaluation is performed in which each employee's performance is assessed solely on the basis of raw KPI data and the threshold values pre-assigned by the organization. This initial evaluation is recorded as the “Raw Employee Performance Data.” Subsequently, a “Contextualized Performance Data” set is generated using machine learning techniques to provide a more comprehensive and holistic assessment of employee performance. As part of this contextualization process, employees are grouped into shift groups and peer groups, which are determined based on the specific shift conditions under which the employee typically works and the colleagues they commonly work alongside. By contextualizing the KPI data in this manner, the system establishes a “curve” that accounts for the typical workload and operational environment of each employee's team. For example, a server who works primarily during low-traffic lunch shifts may receive fewer negative ratings simply due to lower customer interaction volume, whereas a server working high-demand dinner shifts may encounter a higher number of challenging customer interactions purely by volume. The contextualized performance rankings generated through this process are ultimately utilized to create the final employee evaluation views, ensuring a fair and accurate representation of each employee's performance relative to their specific work environment and peer group.

In accordance with an embodiment of the present disclosure, FIG. 6A illustrates a flow diagram representing the process for calculating employee performance evaluations. The process begins at step 602 with the initiation of a timer. At step 604, each Key Performance Indicator (KPI) is analyzed, and at step 606, data corresponding to each employee is analyzed. At step 608, KPI measurement data is loaded into the system from data source C1. Based on the KPI measurements, a performance metric for each employee is calculated at step 610. Subsequently, at step 612, a raw performance ranking is generated for each employee. The employee performance data used for generating these rankings is retrieved from a database at step 616. In parallel, KPI thresholds are configured for each KPI through a web-based user interface at step 618. These configured KPI thresholds are stored at step 614 and are provided as input for calculating the raw performance rankings. At step 620, the raw performance ranking data for each employee and each KPI is stored in a designated repository. This raw performance ranking data is subsequently provided as input to a machine learning-based performance contextualization engine, referenced as engine A, at step 628. Additional inputs for the contextualization engine include employee peer groups, received from data source C2, and employee KPI rankings received from data source C8. Furthermore, shift peer group rankings, received from data source C9 at step 624, are also supplied as input to the performance contextualization engine. The output generated by the machine learning-based performance contextualization engine A is subsequently provided as input to step 660 in FIG. 6C, where further processing occurs for each KPI.

In FIG. 6B, at step 630, a specific shift is selected for analysis. At step 632, a machine learning process is applied to identify historical shifts that are considered peer shifts to the selected shift. The machine learning process further includes, at step 634, the identification of patterns in employee assignments to these peer shifts, determining which employees are typically scheduled for comparable shift conditions. Additionally, at step 636, the shift schedule data is provided as input to the machine learning process, and at step 638, historical point-of-sale (POS) data is supplied to further refine the analysis. At step 640, employee role information is also provided as input to the machine learning process at step 634, facilitating accurate grouping based on role and shift context.

The output of the machine learning process executed at step 632 is utilized for generating shift peer groups, as shown at step 624. Further, data from external source C9 is incorporated into this process to enhance the accuracy of the shift peer group determination. At step 622, the machine learning process executed at step 634 provides input to the generation of employee peer groups. Additionally, input from data source C8 is integrated into this step to ensure comprehensive and context-aware peer group formation.

Continuing in FIG. 6C, at step 660 and 658, each employee and their respective KPI rankings are loaded from data source C1. At step 654, an overall performance evaluation is calculated for each employee. Earned training adjustments are applied to these overall evaluations at step 652, and the final evaluations are stored in a database at step 670. Inputs from data source C6 are also incorporated during the adjustment process at step 652. Additionally, employee timesheet role assignments, received from data source 662, are provided as inputs for calculating the overall performance evaluation at step 644. KPI and role weights, received from data source 664, are also incorporated into this calculation. The earned training adjustments applied at step 652 are further used as input for a web-based user interface that facilitates KPI per role weighting configuration. This configuration is then provided as input at step 666 for determining the KPI and role weights used in subsequent evaluations. The method concludes with all adjustments being updated and the overall performance evaluations being finalized and stored, thereby completing the process.

FIG. 6D illustrates a process for awarding tokens within the method, according to an embodiment of the present disclosure. At step 672, the token allocation process is initiated. At step 674, for each employee, earned awards are calculated based on their performance data and a predefined award schedule. The employee performance data is received from data source C2, as shown at step 682. Additionally, the KPI ranking award schedule is provided as input at step 680. The KPI Threshold Award Token Configuration is performed via a Web User Interface (WebUI) at step 686.

The earned awards are subsequently used as input for calculating the tokens awarded to employees, as depicted at step 690. At step 676, the system determines whether a sufficient number of tokens are available for allocation. If a sufficient quantity of tokens is available, the tokens are allocated to employees on a pro-rata basis at step 692. This allocation is also recorded and communicated to external source C7.

In the event that the available tokens are insufficient, the system prompts the organization at step 678 to allocate additional tokens. Following this step, the process proceeds to step 692, where the tokens are allocated according to the updated availability. Finally, at step 693, a report of the token allocation is generated and recorded.

FIG. 6E illustrates a flowchart of the employee token redemption process, according to an embodiment of the present disclosure. At step 694, the Employee Redemption Portal is opened. This portal provides employees with a secure and interactive interface through which they can view and redeem tokens that they have earned based on their performance evaluations and KPI rankings.

At step 695, the system determines the number of tokens currently available for the employee. This step involves querying the database to retrieve the total balance of tokens that have been allocated to the specific employee through previous performance evaluations and token award processes (as described in FIG. 6D).

Once the available token balance is determined, the system proceeds to step 696. At this stage, a set of redemption options is presented to the employee. These options represent the various rewards or benefits that employees can exchange for their accumulated tokens. The redemption options are configured and provided as inputs from the Award Token Redemption Options module, represented as data input 691. The system also factors in the number of available tokens for the employee, represented as input 699, to ensure that only the rewards for which the employee has sufficient tokens are presented.

At step 697, the system facilitates the employee's selection of a redemption option. This interaction may be performed via the web-based Employee Redemption Portal interface, which allows employees to browse available options and make their selections based on their token balance.

At step 698, once the employee has made their selection, the redemption order is processed. This includes validating the selection, confirming token availability, and deducting the appropriate number of tokens from the employee's balance. Upon successful processing of the redemption request, the order information is transmitted to system component C7, which may handle the fulfillment of the reward (e.g., initiating the delivery of a physical item, issuing a gift card, or granting access to a particular benefit or privilege).

The process ensures a seamless experience for employees to redeem their earned tokens while maintaining accurate records of token balances and redemptions.

In an embodiment of the invention organizations may enroll in the Awards and Rewards system, which is designed to incentivize and recognize employee performance through a flexible token-based framework. The system allows organizations to pre-purchase tokens that are awarded automatically to employees as they achieve predefined Key Performance Indicator (KPI) goals. These goals may be configured to apply organization-wide or tailored to individual employees based on their roles or specific objectives. The token itself is customizable, enabling the organization to assign a unique name, graphic, and branding to align with internal recognition programs or company culture. Additionally, at the time of enrollment, the system provides pre-configured or custom token options, such as “Kudos” or “Coins,” which organizations may select to simplify implementation. Idea being that a coffee shop may call their tokens “Beans” or an Ice Cream Parlor may call them “Sprinkles”, options that are of their choosing/branding.

In practice, organizations may establish various criteria for awarding tokens. For example, an organization may reward all employees with a token, for achieving perfect attendance over a six-month period. Alternatively, tokens may be awarded to a specific role or department, such as cashiers, who meet sales performance targets, while excluding other roles from this particular incentive. Tokens can also be used to encourage ongoing engagement with the platform, for example by awarding tokens to employees who regularly log into the system to review their performance evaluations or complete assigned training modules.

The tokens earned by employees are accumulated within their personal accounts on the system. Employees can later redeem these tokens through an online rewards portal, which provides access to organization-approved products and services. Redemption options typically include company-branded merchandise, promotional items, or gift cards. To facilitate this process, the system can integrate with promotional product providers and gift card vendors, offering a seamless experience for employees to exchange their tokens for tangible rewards. This system not only promotes engagement and motivation among employees but also aligns performance incentives with organizational goals and recognition strategies.

In the embodiment illustrated by the method disclosed in FIGS. 6A-6E, the current invention implements a multi-stage process that combines static analysis, machine learning-based analysis, and software component analysis (SCA) to automatically detect security vulnerabilities within a computer program's source code. This process does not merely analyze data conceptually but involves specific technological operations performed by configured machines, processors, and memory executing defined data transformation procedures on computer-readable data structures, such as abstract syntax trees (ASTs) and vectorized call graphs.

As shown in the method disclosed in FIGS. 6A-6E, the system obtains the source code from a client codebase and transforms it into an abstract syntax tree (AST). This transformation itself is a technical process that parses and structures code into a tree representation, capturing the syntactic structure necessary for subsequent machine learning operations. The AST is further processed by flattening it into a sequence of structured tokens, which encode both the semantic and syntactic features of the source code. These structured tokens are not abstract ideas but are concrete machine-readable data structures that enable the system to map them into integer vectors using natural language processing (NLP) techniques, specifically Byte Pair Encoding (BPE). BPE improves data handling by compressing and logically encoding frequent token patterns, which allows the system to handle large vocabularies present in source code efficiently.

As further illustrated in the method disclosed in FIGS. 6A-6E, the vectorized call graph is generated by integrating the AST with control flow and data flow representations of the source code. This vectorized call graph is a structured and embedded data model representing the calling relationships between subroutines, which the system uses to perform static analysis and software component analysis (SCA). This processing enables automatic identification of third-party libraries, versions, and known vulnerabilities through direct interaction with common vulnerabilities and exposures (CVEs) databases. By incorporating dynamic analysis features during compilation, the system detects vulnerabilities related to outdated or vulnerable software components, which are not discernible through static analysis alone.

The machine learning model within the system further operates on the vectorized data to detect vulnerabilities that are difficult to capture with rule-based static analysis alone. The model, based on a deep neural network architecture such as a transformer, employs a masked, multi-head self-attention mechanism to process the structured input. It predicts the presence or absence of security vulnerabilities in the code, utilizing learned embeddings of function-level ASTs, which have been pre-trained and fine-tuned on large corpora of labeled and unlabeled source code. These operations are not mental steps but specific machine-implemented processes that improve the computer's ability to identify complex security vulnerabilities in code, enabling faster and more accurate detection compared to traditional systems.

Moreover, the system performs real-time differential analysis on new code changes and integrates feedback from human experts. This feedback is incorporated into the training data, allowing the machine learning model to continuously improve its predictive accuracy, thereby providing a technological improvement over prior-art static analysis tools that lack learning capability.

In sum, the invention, as depicted in the method disclosed in FIGS. 6A-6E, provides a specific technological solution to the technical problem of efficiently and accurately detecting security vulnerabilities in source code. It does so by employing specific computing components, machine learning algorithms, and data processing techniques that transform raw source code into actionable insights, thereby improving the operation of the computer system itself rather than merely performing a mental act or an abstract idea.

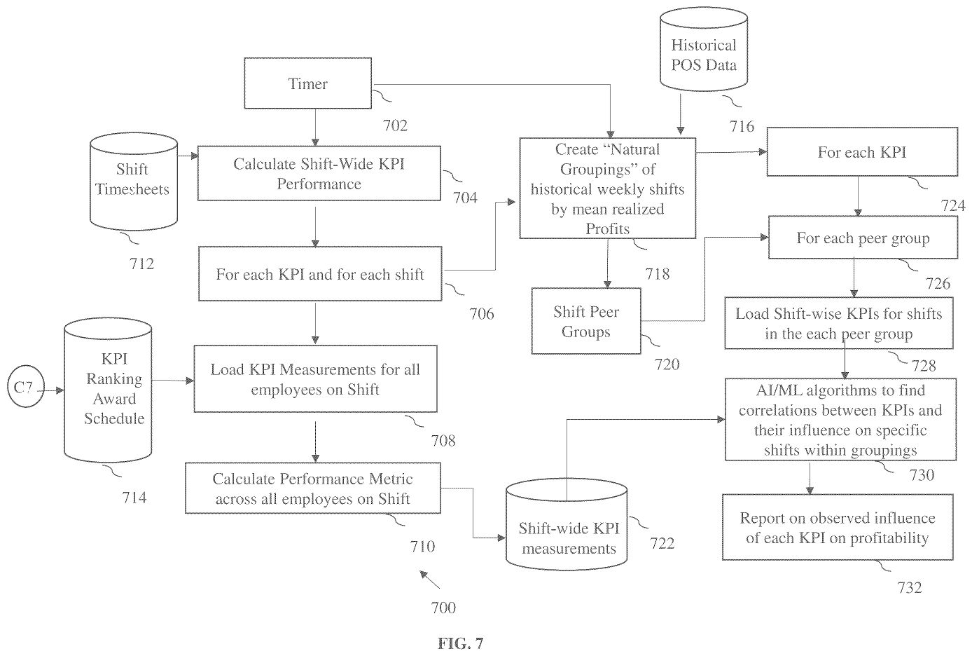

FIG. 7 illustrates a method 700 of performing KPI Reflection, according to an embodiment of the present disclosure. This method allows an organization to analyze key performance indicators (KPIs) across various shifts and employee groups, identifying patterns and correlations that can inform decision-making and workforce optimization.

At step 702, a timer starts, marking the beginning of a scheduled analysis cycle. The system may execute this process at pre-defined intervals (e.g., daily, weekly) or on demand.

At step 704, the system calculates Shift-Wide KPI Performance. This step aggregates performance data for a specific shift to determine how the team collectively performed against each KPI. To perform this calculation, shift timesheets are retrieved and provided as input at 712. These timesheets include employee attendance records, assigned roles, shift durations, and other relevant data necessary to contextualize the KPI analysis.

At step 706, the system performs detailed analysis for each KPI and for each shift. This involves iterating through every KPI being measured and analyzing how employees on a specific shift performed with respect to each of those KPIs.

At step 708, all KPI measurements are loaded for the employees assigned to each shift. This ensures the system has comprehensive performance data for every shift under consideration. As part of this step, a KPI ranking award schedule, retrieved from component C7, is provided as input at 714. This award schedule defines thresholds and benchmarks for KPI achievements and may influence how the shift performance is evaluated.

At step 710, the system calculates a performance metric that represents the collective performance across all employees on the shift. This consolidated performance metric is stored in a Shift-Wide KPI Measurements database at 722. These records serve as historical data points for further analysis and machine learning operations.

Once the shift-wide KPI measurements are recorded, they are provided as input to machine learning algorithms at 730. These algorithms analyze the data to find correlations between KPIs and their influence on specific shifts within identified groupings. The goal is to understand how different KPIs interact and affect overall shift performance, enabling the organization to fine-tune KPI weighting or staffing decisions.

An additional input is provided to the machine learning algorithms at 728, which may include external factors, contextual data, or additional shift metrics, further enriching the correlation analysis.

Returning to step 706, where each KPI and shift are analyzed, the system also provides inputs at 718 to create natural groupings of historical weekly shifts. These groupings may be based on mean realized performance, similarity in staffing, workload, time of day, or other characteristics that define a shift type or peer group.

The output of these groupings is provided to the Shift Peer Groups module at 720. These peer groups categorize shifts that share similar traits, ensuring that performance comparisons and analyses are fair and contextually accurate.

In addition, the output is supplied to step 724, where each KPI is further analyzed in relation to these shift peer groups. For each peer group, the output is provided at 726, and used at 728, where shift-wide KPIs are loaded for all shifts within each peer group. This data set allows the machine learning algorithms at 730 to perform a more comprehensive analysis.

By feeding shift-specific KPI data and peer group information into the machine learning algorithms, the system can identify correlations, detect patterns, and gain actionable insights that inform future KPI strategies, staff scheduling, and performance evaluations.

Organizations have the option to enroll in the invention training system, which is designed to enhance employee performance by addressing individual areas of improvement. The system automatically analyzes an employee's KPI rankings and identifies specific metrics that are negatively impacting their overall performance score.

Based on this analysis, the system recommends targeted training videos or interactive sessions tailored to the employee's unique needs. For example, if an employee's ranking is reduced due to frequent tardiness, the system may suggest a training module on time management and the importance of punctuality. These training opportunities are presented through the employee's dashboard or learning portal.

Completion of the recommended training sessions not only helps the employee improve their knowledge and skills but also has a direct impact on their KPI scores. Successfully completing relevant training modules may restore lost points on related KPIs, thereby improving the employee's overall performance ranking. Additionally, employees may earn kudos and awards tokens through the system's integrated recognition framework, further incentivizing participation and engagement.

The invention provides robust support for integration with both the ecosystem and external enterprise software platforms. The system includes a comprehensive Application Programming Interface (API) that facilitates seamless data exchange and interoperability.

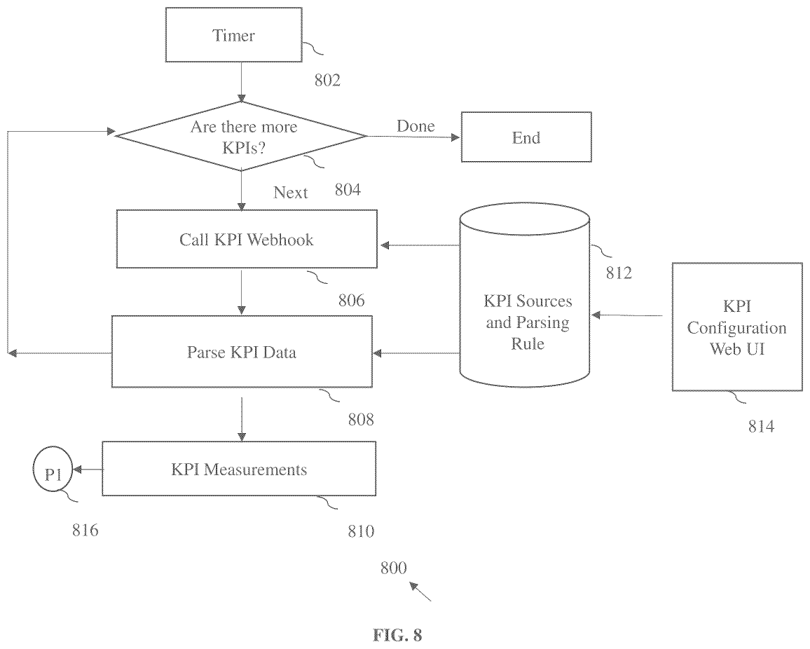

FIG. 8 discloses a flowchart 800 illustrating a method of configuring Key Performance Indicators (KPIs) on a web user interface. Initially, at step 802, a timer initiates the process. The method then flows to step 804, where it checks whether more KPIs are available. If additional KPIs are identified, the method moves to step 806, where the KPI webhook is called. The webhook call is based on the KPI sources and parsing rule database, which is stored at step 812.

Subsequently, at step 808, the KPI data is parsed based on the KPI sources and parsing rules, which are also maintained in the database at step 812. After parsing, the KPI measurements are performed at step 810 and the resulting data is stored in memory location P1, as indicated at step 816. Following the measurement, the method loops back to step 804 to determine whether more KPIs are present. If additional KPIs are found, the process proceeds to step 806 again to call the next KPI using the KPI webhook. In the absence of more KPIs, the method terminates.

The KPI web configuration user interface (UI) 814 allows an organization to import raw performance data from external sources, including Point of Sale (POS) systems, time clocks, inventory systems, and the broader the performance indicator ecosystem. Many leading industry data sources come with pre-configured integrations. Additionally, the system supports the integration of any data source through direct CSV file import or HTTP(s) Webhooks. The configured Webhooks must return the performance data in JSON format, which should include details such as the Time Period of the measurements, the names of the KPIs being measured, the Employee ID, and the corresponding measurements.

For instance, a retail store might use a POS system to track sales per shift as a KPI. The POS system would send the sales data via a Webhook in JSON format, including information such as “Time Period: 09:00-17:00”, “KPI: Sales Per Shift”, “Employee ID: 12345”, and “Measurement: $500”. The parsed data would then be stored in the database for analysis.

Alternatively, a file import interface can be configured where CSV-formatted files are used to import KPI data. This method is useful for bulk data imports, which are compatible with The system AI features to detect potential new KPIs that could statistically influence shift profitability. For example, a CSV file might contain columns such as “Employee ID”, “Sales Volume”, and “Shift Hours”, enabling the system to analyze correlations between working hours and sales productivity.

In scenarios where multiple data sources are utilized, such as integrating both PoS data and time clock data, the system can combine these inputs to provide a comprehensive analysis. This combined data can help identify correlations between employee working hours and sales performance, enabling more informed decision-making regarding staffing and shift management.

An advantage of the system is its seamless integration with an organization's existing digital infrastructure, allowing for real-time data exchange and enhanced operational efficiency. Key integration points include Point-of-Sale (POS) systems, which provide real-time sales data and employee transaction metrics essential for accurate KPI evaluations. Shift schedulers are integrated to pull shift assignments and attendance data, enabling more accurate contextualization of KPIs based on when and where employees are working. Additionally, the system connects with broader management software suites, such as those handling HR, payroll, and workforce management functions, to create a comprehensive view of employee performance and streamline administrative tasks. These integrations ensure that the system supports real-time data imports and exports, enhancing the accuracy of performance evaluations, delivering timely training recommendations, and automating reward distributions. This interoperability ultimately reduces administrative burden and fosters a more responsive and effective performance management ecosystem.

An advantage of the invention is its ability to provide employees with real-time access to their performance evaluations through a user-friendly website and mobile application. Once evaluations are generated and published, employees can easily view both their current and recent performance evaluations, including overall and KPI-specific rankings. The system presents their ranking trends over time in an intuitive graphical format, enabling employees to track their progress and understand performance fluctuations. Additionally, it offers system-generated suggestions that identify the specific changes an employee can make to have the most significant positive impact on their ranking. Real-time notifications alert employees when their ranking is trending downward, encouraging them to take immediate corrective action and avoid potential declines in performance levels. The system also provides detailed insights into which specific KPIs are most significantly influencing their overall ranking, empowering employees with actionable information. Furthermore, employees identified as being on the verge of moving up or down a performance tier receive targeted notifications through the app, informing them of their current strengths or areas for improvement. This proactive feedback mechanism helps reinforce positive behavior and offers timely opportunities for employees to do courses-correct before performance issues become habitual, ultimately fostering a culture of continuous improvement and engagement.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other examples features of example embodiments may be embodied in the form of an apparatus, method, system, computer program, tangible computer readable medium and tangible computer program product. For example, the aforementioned methods may be embodied in the form of a system or device, including, but not limited to, any of the structures for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The readable medium or storage medium may be a built-in medium installed inside a computer device's main body, or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include, but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. An artificial intelligence employee evaluation system comprising:
at least one input device;
at least one output device;
one or more memory components;
one or more processors communicatively coupled to one or more input devices, one or more output devices and a memory component; and machine-readable instructions stored in the memory component that cause the artificial intelligence employee evaluation system to perform at least the following when executed by the one or more processors:
evaluate quantitatively employees based on a set of key performance indicators (KPIs) stored in memory;
read KPI data from a source;
weight the KPI for an employee based on the role of the employee;
compare KPI employee performance against a set of employer KPI thresholds in a employee rankings module based on the employer KPI thresholds;
classify employees into an overall ranking level using KPI employee performance in an artificial intelligence module; and
generate an evaluation report for each employee/role pairing and output the evaluation report.

2. The artificial intelligence evaluation system of claim 1, further comprising:
add additional customer-defined KPIs through an input device and store it in memory.

3. The artificial intelligence evaluation system of claim 1, wherein the employee ranking module contains a performance contextualization engine with machine learning used to observe overall trends in shifts and corelated performance metrics to adjust the observed performance data in order to reflect the “degree of difficulty” of the working conditions.

4. The artificial intelligence evaluation system of claim 1, further comprising:
rank employees against their peer group.

5. The artificial intelligence evaluation system of claim 1, further comprising:
at least one sensor to automatically capture KPI data automatically;
circuity to properly capture the output of the sensor;
a KPI data logger module to store the captured data from the sensor; and
a timer module to run the artificial intelligence evaluation system in real time where the running frequency is programmable.

6. An artificial intelligence employee evaluation system comprising:
at least one input device;
at least one output device;
one or more memory components;
one or more processors communicatively coupled to one or more input devices, one or more output devices and a memory component; and machine-readable instructions stored in the memory component that cause the artificial intelligence employee evaluation system to perform at least the following when executed by the one or more processors:
evaluate quantitatively employees based on a set of key performance indicators (KPIs) stored in memory;
read KPI data from a source; and
weight the KPI for an employee based on the role of the employee;
an employee feedback interface which provides evaluation and rank data; and
an output providing evaluation feedback updated one configurable timer. Wherein the system optionally provides employees with tips on how to improve.

7. The artificial intelligence employee evaluation system of claim 6 further comprising:
a set of online training classes suggested based on KPI evaluation data and employer approval;
a module tracking the completion of suggested training classes; and
an employee evaluation module which factors into the evaluation completed training.
wherein the employee evaluation module is a software module implemented using artificial intelligence.

8. The artificial intelligence employee evaluation system of claim 6, further comprising:
a set of token rewards earned through a requirement wherein the requirement is selected from the group consisting of:
a set of KPI performance thresholds achieved,
completion of suggested training, and
regular usage of an employee portal.

9. A computer method for employee evaluation using artificial intelligence comprising the steps of:
one or more processors communicatively coupled to one or more input devices, one or more output devices and a memory component; and
executing machine-readable instructions stored in the memory component of a computer device with an artificial intelligence module;
evaluating quantitatively employees based on a set of key performance indicators (KPIs) stored in memory;
reading KPI data from a source;
weighting the KPI for an employee based on the role of the employee;
comparing KPI employee performance against a set of employer KPI thresholds in a employee rankings module based on the employer KPI thresholds;
classifying employees into an overall ranking level using KPI employee performance in an artificial intelligence module; and
generating an evaluation report for each employee/role pairing.

10. The computer method of claim 9, further comprising:
adding additional customer-defined KPIs through an input device and storing the KPIs in memory.

11. The computer method of claim 9, further comprising:
ranking employees using performance contextualization software and machine learning;
observing overall trends in shifts and corelated performance metrics; and
adjusting the observed performance data in order to reflect the “degree of difficulty” of the working conditions.

12. The computer method of claim 10, further comprising:
ranking employees against their peer group.

13. The computer method of claim 9, further comprising:
capturing KPI data automatically through at least one sensor;
capturing the output of the sensor through the proper circuity to property;
storing the capture data from the sensor in a KPI data logger module; and
running the artificial intelligence module in real time with a timer module where the running frequency is programmable.

14. The computer method of claim 9, further comprising:
weighting the KPI for an employee based on the role of the employee;
providing employee feedback through a user graphical interface;
wherein the user graphical interface provides evaluation and ranking data; and
wherein the user graphical interface optionally provides employees with tips on how to improve.

15. The computer method of claim 9, further comprising:
suggesting online training classes based on KPI evaluation data and employer approval.
tracking the completion of suggested training classes; and
evaluating employees based on KPI evaluation data and completed training. Wherein the employee evaluation software is optionally implemented using artificial intelligence.

16. The computer method of claim 15, further comprising:
training in the artificial intelligence employee evaluation software using completed training and historical employee KPI data.

17. The computer method of claim 9, further comprising
rewarding employees with a set of tokens if a requirement is met Wherein the requirement is selected from the group consisting of:
a set of KPI performance thresholds achieved,
completion of suggested training, and
regular usage of an employee portal.
